(19) United States
(12) Patent Application Publication
(10) Pub. No.: US 2010/0279671 A1
(43) Pub. Date: Nov. 4, 2010

(54) COMMUNICATION APPARATUS AND COMMUNICATION METHOD

(75) Inventor: Akihiro Ohmoto, Kanagawa (JP)

Correspondence Address: Seed Intellectual Property Law Group PLLC, 701 Fifth Avenue, Suite 5400, Seattle, WA, 98104, US

(73) Assignee: PANASONIC CORPORATION, Osaka (JP)

(21) Appl. No.: 12/810,809

(22) PCT Filed: Oct. 23, 2008
(86) PCT No.: PCT/JP2008/003009

§ 371 Date: Jun. 25, 2010

(30) Foreign Application Priority Data
Dec. 27, 2007 (JP) 2007-337596

(51) Int. Cl. H04W 4/00

(52) U.S. Cl. 455/415

(57) ABSTRACT

There are provided a communication apparatus and a communication method that enable notification of caller information in an oversea call. A portable phone 100 that is an example communication apparatus has an operation section 16 for accepting an operation input; a storage section 13 for storing information showing a location of the portable phone 100; and a control section 17 for effecting control so as to make a voice phone call with an addition of a predetermined message in accordance with the information when the operation section 16 instructs voice phone call.

### TECHNICAL FIELD

The present invention relates to a communication apparatus and a communication method and, more particularly, a communication apparatus having a function of notifying caller information in an international call and a communication method.

### BACKGROUND ART

Caller ID service is service for displaying a phone number of a telephone set of a call source on a telephone set of a called party. In the service, phone number information about a telephone set of a call source received by switching equipment is transmitted to a telephone set of a called party. The telephone set of the called party analyzes the received information and displays the thus-analyzed phone number, thereby displaying the phone number of the telephone set of the call source. FIG. 5(a) shows an example display of a name along with a phone number of a call source on a display screen of a telephone set of a called party.

When a telephone call is made in the manner as mentioned above, the phone number of the call source is very often transmitted to a called party in an initial state. When the call source does not desire to send his/her phone number for any reasons, three-digit prefix “184” is followed by a phone number, whereby a call can be made with no-caller ID settings.

In the meantime, it is also possible to prevent transmission of a phone number to a called party in an initial state by means of settings of a telephone set or a line (a normally no-caller ID service). However, when the call source desires to notify his/her phone number for any reasons, three-digit prefix “186” is followed by the phone number, whereby the phone number can be notified in connection with the telephone call.

A private branch exchange system that notifies a caller ID in synchronism with an incoming call signal regardless of the scale of the system has hitherto been known as an example apparatus for notifying a caller ID (see; for instance, Patent Document 1).

Patent Document 1: JP-2007-174496

### DISCLOSURE OF THE INVENTION

### Problem that the Invention is to Solve

However, in the case of an oversea incoming call or an incoming call made by a general subscriber phone through transfer services, the call sometimes lacks specific information. As a result, the caller ID is not notified, and a message “Impossible to notify” is sometimes displayed on a display screen of a telephone set of the called party as shown in FIG. 5(a). In this case, a called party can neither ascertain the calling party nor determine whether or not to start a telephone conversation.

An oversea communication line is often incompatible with information for transmitting notification/non-notification of caller information, such as the three-digit prefixes “184” and “186” employed in Japan. In such a case, the caller information cannot be notified, and caller information cannot be notified to a called apparatus. In this case, the caller ID function does not operate for an oversea incoming call, and a message “Impossible to notify” appears. Consequently, the calling party is not ascertained, and the incoming call is misunderstood as a prank phone call.

The present invention has been conceived in view of the circumstance and aims at providing a communication apparatus and a communication method that enable notification of caller information in an oversea phone call.

### Means for Solving the Problem

In order to accomplish the objective, a first communication apparatus of the present invention includes: an operation section that accepts an operation input; a storage section that stores information indicating a location of the communication apparatus; and a control section that performs control operation so as to make a voice phone call with an addition of a predetermined message in accordance with the information when the operation section instructs the voice phone call.

By the configuration, a voice phone call is made with an addition of a predetermined message according to information about the communication apparatus that is a call source. Therefore, even when the call source is outside Japan and when caller information is lost in a communication line before arriving at a called party, information about the call source can be notified as a predetermined message, so that anxiety of the called party arising from an oversea call can be resolved.

A second communication apparatus of the present invention includes: an operation section that accepts an operation input; a storage section that stores information indicating a location of a communication apparatus of a call destination; and a control section that performs control operation so as to make a voice phone call with an addition of a predetermined message in accordance with the information when the operation section instructs the voice phone call.

By the configuration, a voice phone call is made with an addition of a predetermined message according to information about a communication apparatus of a call destination that is a called party. Therefore, even when the called party is outside Japan and when caller information is lost in a communication line before arriving at the called party, information about the call source can be notified as a predetermined message, so that anxiety of the called party arising from an oversea call can be resolved.

A third communication apparatus of the present invention is configured such that the storage section stores information including a phone number as the information; and that the control section determines, based on the information about the phone number, whether to make the voice phone call with the addition of the predetermined message.

By the configuration, a determination is made as to whether or not the called party is at home or abroad according to the phone number of the communication apparatus of the call source or the phone number of the call destination that is a called party. Since a voice phone call is made with an addition of a predetermined message only when the called party is abroad, anxiety of the called party in an oversea call can be resolved.

A fourth communication apparatus of the present invention is configured such that the storage section stores information including MM information as the information; and that the control section determines, based on the MM information, whether to make the voice phone call with the addition of the predetermined message.

By the configuration, a determination is made, from the MM Information about the communication apparatus, as to whether or not the called party is at home or abroad. Since a voice phone call is made with an addition of a predetermined message only when the called party is abroad, anxiety of the called party in an oversea call can be resolved.

A fifth communication apparatus of the present invention is configured such that the storage section stores information including GPS information as the information, and that the control section determines, based on the GPS information, whether to make the voice phone call with the addition of the predetermined message.

By the configuration, a determination is made, from the GPS Information about the communication apparatus, as to whether or not the called party is at home or abroad. Since a voice phone call is made with an addition of a predetermined message only when the called party is abroad, anxiety of the called party in an oversea call can be resolved.

A sixth communication apparatus of the present invention is configured such that the predetermined message includes information about a phone number or a user name of the communication apparatus.

By the configuration, caller ID information about a call source including a phone number or name of the communication apparatus that is the call source is displayed on a display screen of a communication apparatus of a call destination that is a called party. Therefore, anxiety of the called party arising in an oversea call can be resolved.

A seventh communication apparatus of the present invention is configured such that the predetermined message is a message generated by the control section in accordance with the operation input performed by the operation section.

By the configuration, a message generated with the intent of a user of the communication apparatus that is the call source is displayed on a display screen of a communication apparatus of a call destination that is a called party. Therefore, anxiety of the called party arising in an oversea call can be resolved.

An eighth communication apparatus of the present invention is configured such that the predetermined message includes country information based on a latitude or a longitude where the communication apparatus is located.

By the configuration, country information including a latitude or longitude of the communication apparatus that is a call source is displayed on a display screen of a communication apparatus of a call destination that is a called party. Therefore, anxiety of the called party arising in an oversea call can be resolved.

A ninth communication apparatus of the present invention is configured so as to include an incoming call section that receives, from a communication apparatus of a call source, a voice call having an additional message including information about a phone number of the communication apparatus of the call source, and is also configured such that the storage section stores information about the phone number of the communication apparatus and a user name of the call source associated with each other; and that the control section converts the phone number included in the message into a corresponding user name by reference to the storage section.

By the configuration, the phone number described in an incoming message is converted into a name of the call source by reference to a phone directory, and the name can be displayed. Therefore, anxiety of the called party arising in an oversea call can be resolved.

A tenth communication apparatus of the present invention is configured so as to further include an incoming call section that receives, from a communication apparatus of a call source, a voice call having an additional message including information about a country where the communication apparatus of the call source is located, and is also configured such that the storage section stores map information corresponding to the information about the country where the communication apparatus of the call source is located; and that the control section displays, on a display section, the map information corresponding to the country information included in the message, by reference to the storage section.

By the configuration, when the incoming message includes country information, map information corresponding to the country information about a call source is displayed. Therefore, anxiety of the called party arising in an oversea call can be resolved.

A first communication method of the preset invention is for use with a communication apparatus including: an operation step of accepting an operation input; and a step of executing control so as to make a voice phone call with an addition of a predetermined message in accordance with information about a location of the communication apparatus when the voice phone call is instructed in the operation step.

According to the method, a voice phone call is made with an addition of a predetermined message according to information about the communication apparatus that is a call source. Therefore, even when the call source is outside Japan and when caller information is lost in a communication line before arriving at a called party, information about the call source can be notified as a predetermined message, so that anxiety of the called party arising from an oversea call can be resolved.

A second communication method of the present invention is also for use with a communication apparatus including: an operation step of accepting an operation input; and a step of executing control so as to make a voice phone call with an addition of a predetermined message in accordance with information about a location of a communication apparatus of a call destination when the voice phone call is instructed in the operation step.

By the configuration, a voice phone call is made with an addition of a predetermined message according to information about a communication apparatus of a call destination that is a called party. Therefore, even when the called party is outside Japan and when caller information is lost in a communication line before arriving at the called party, information about the call source can be notified as a predetermined message, so that anxiety of the called party arising from an oversea call can be resolved.

### ADVANTAGE OF THE INVENTION

As mentioned above, according the communication apparatus and the communication method of the present invention, a voice phone call is made with an addition of a predetermined message in accordance with information about a call source. For this reason, even when the call source is outside Japan and when caller information is lost in a communication line before arriving at a called party, information about the call source can be notified as a predetermined message, so that anxiety of the called party arising from an oversea call can be resolved.

Moreover, a voice phone call is made with an addition of a predetermined message according to information about a called party. Therefore, even when the called party is outside Japan and when caller information is lost in a communication line before arriving at the called party, information about the call source can be notified as a predetermined message, so that anxiety of the called party arising from an oversea call can be resolved.

### BRIEF DESCRIPTION OF THE DRAWINGS

FIG. 1 It is a block diagram showing an example basic constituent element of a portable phone of an embodiment of the present invention.

FIG. 2 It is a flowchart for describing example operation of the portable phone of the embodiment of the present invention.

FIG. 3 It is a flowchart for describing example message setting processing using a text information setup function of the portable phone of the embodiment of the present invention.

FIG. 4 It is a flowchart for describing another example operation of the portable phone of the embodiment of the present invention.

FIG. 5 It is an example display of a display screen of the portable phone of a called apparatus.

### DESCRIPTIONS OF THE REFERENCE NUMERALS AND SYMBOLS

100 PORTABLE RADIO APPARATUS
11 ANTENNA
12 RADIO SECTION
13 STORAGE SECTION
14 SOUND SECTION
15 POSITIONAL INFORMATION ACQUISITION SECTION
16 OPERATION SECTION
17 CONTROL SECTION
18 POWER SUPPLY SECTION
21 DISPLAY SECTION
22 ILLUMINATION SECTION
23 VIBRATION SECTION

### BEST MODE FOR IMPLEMENTING THE INVENTION

A communication apparatus and a communication method of an embodiment of the present invention will be hereunder described by reference to the drawings.

The communication apparatus of the embodiment of the present invention is a portable phone, a personal digital assistant (PDA) with a phone function, a personal computer (PC), and the like. The present invention is described by taking a portable phone as an example.

The communication apparatus of the present embodiment of the present invention determines whether a communication apparatus of a party on the other side is at home or abroad. Such a determination is made from a phone number of, MM information about, or GPS information about the communication apparatus of the party on the other side.

The MM information is international time information that is specified by a 3GPP (the 3^{rd} Generation Partnership Project) that is a standard specification for a mobile communication system and that is received by a portable phone from a server in a network. For instance, in the case of GMT+9, the time information shows a Japan time. The MM information is periodically acquired from an external server. Once the MM information has been acquired and stored in a storage section, the MM information in the storage section remains stored even when the power is shut off and the phone is again started. When a location of the portable phone is changed, different MM information is acquired, and the information in the storage section is updated.

The communication apparatus of the embodiment of the present invention generates a message including caller information. An example function of generating such a message is a text information setup function. An example text information setup function is a “Chaku-moji (Registered Trademark)” message. According to the text information setup function, even when the caller information is lost in a communication line as in the case of the related art, it is possible to notify the caller information to a called apparatus as a predetermined message. A message involving use of the text information setup function can be caused to include caller ID information (a phone number and a name of a calling party), a message generated by an operation section under a user's instruction, and country information (latitude and longitude information, or the like).

Next, there is provided a general description about a case where the portable phone of the embodiment of the present invention makes a call from abroad. In this case, the portable phone of the calling party determines whether a visitor district is abroad, by use of “MM Information,” or the like, received from a network. A control section 17 to be described later performs processing.

In a case where the portable phone of the calling party is abroad and when the portable phone makes a voice phone call, pre-registered data (caller information) are automatically cited in a message involving use of a text information setup function, and a voice phone call including the message involving use of the text information setup function is made. Thus, caller information is notified to the portable phone of a called party. Processing is performed by the control section 17 to be described later.

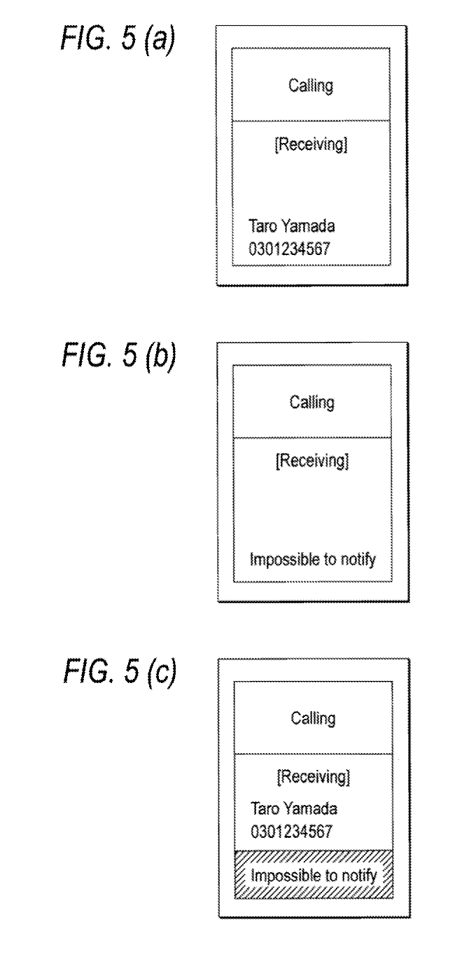

The portable phone of the embodiment of the present invention is assumed to have a preset value for determining whether to make a call using the text information setup function during an oversea call and to enable the user to perform turn-on or turn-off operation. In this case, the caller information designates phone number information (a name, a phone call, and the like), a message previously generated by the user, country information, and the like. FIG. 5(c) is a drawing showing an example display, on a screen of the portable phone of the called party, of a name and a phone number as a message involving use of the text information setup function. The control section 17 performs processing in accordance with an operation input performed by way of; for instance, an operation section 16 to be described later. A display is provided by a display section 21.

When the phone number is included as caller information, the called party verifies the phone number against a phone directory. When there are matched data, a name assigned to data registered in the phone directory can also be displayed. The control section 17 to be described later performs verification processing, and the display section 21 performs display processing.

When country information about a call source is included in the caller information, the called party can display map information corresponding to the country information. Processing makes it possible to display corresponding map information by means of previously storing the map information corresponding to country information in a storage section 13 to be described later and making a reference to the country information about the call source through use of a control section 17.

The call may also be determined to be abroad by use of a positioning function fulfilled by a GPS (Global Positioning System). A positional information acquisition section 15 performs positioning processing, and the control section 17 determines whether or not the call source is abroad.

The text information setup function is one of functions of the portable phone and corresponds to a function of displaying a text message on a screen of an apparatus of a called party when a call is made. A message including a maximum of 10 texts can be displayed on a portable phone apparatus of a called party during ringing operation, and the message is utilized for transmitting business, urgency, or the like. Although a message remains in a received call history, as well, both the calling party and the called party are required to have compatible apparatuses in order to utilize the message service.

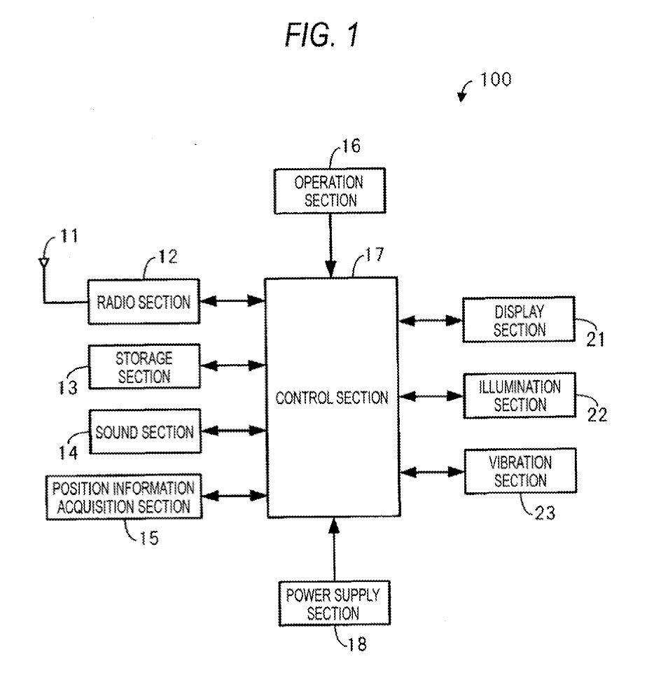

An example configuration of the portable phone of the present embodiment of the present invention is now described. FIG. 1 is a block diagram showing basic constituent elements of the portable phone of the embodiment of the present invention.

A portable phone 100 shown in FIG. 1 has an antenna 11, a radio section 12, a storage section 13, a sound section 14, a positional information acquisition section 15, an operation section 16, a control section 17, a power supply section 18, a display section 21, an illumination section 22, and a vibration section 23.

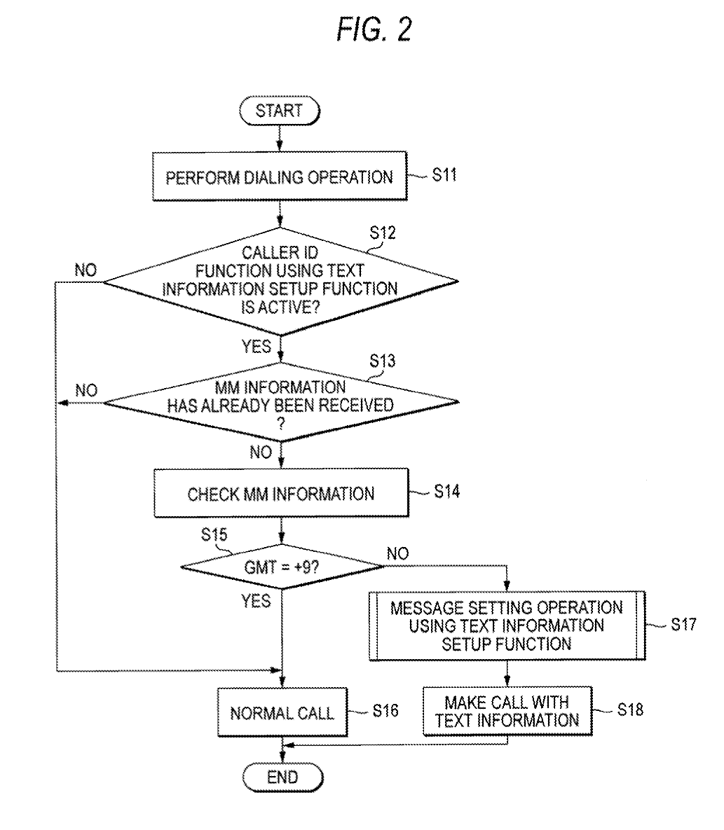

The control section 17 is a central processing unit that controls entire operation of the portable phone according to various programs in the storage section 13. The storage section 13 is nonvolatile memory (internal memory) and made up of; for instance, flash memory. The storage section has a program area and a data area. The program area stores programs for implementing the present embodiment in accordance with operating procedures shown in FIGS. 2 through 4 to be described later.

The storage section 13 is internal memory having a work area made up of; for instance, DRAM (Direct Random Access Memory), SDRAM (Synchronous DRAM), or the like. The storage section 13 enables connection of a recording medium that is removable, transportable memory for supplying captured image data, various types of data, and programs to the outside. The recoding medium can be built from; for instance, a smart medium, an IC card, and the like.

The storage section 13 can store information showing a location of the portable phone 100 (phone number information, MM information, GPS information, and the like). The MM information or the GPS information is acquired from an external server by way of a network and stored in the storage section 13. Information (phone number information, or the like) showing a location of another portable phone that is a call destination for the portable phone 100 can be stored.

The radio section 12 acquires a signal from a receiving side of a transceiving duplexer connected to the antenna 11, demodulates the thus-acquired signal into a received baseband signal, and outputs sound data from the sound section 14. The radio section 12 encodes voice data input from a voice microphone included in the sound section 14 into a transmission baseband signal, sends the transmission base band signal to a transmission side of the transceiving duplexer, and lets the signal output from the antenna 11.

In the meantime, display data received by way of the radio section 12 by means of an electronic mail function or a connection to the Internet are delivered to the display section 21, such as an LCD (liquid crystal display), and displayed and output. The display section 21 is for displaying text information, a television image, various messages, and the like, at high quality. In addition to the display section 21, another sub-display section can also be provided on a back of a main unit. The sub-display section displays; for instance, a current time and date, a simple message, an icon, or the like.

The radio section 12 has a function of serving as a called section that performs voice call receiving operation with an addition of a message including information about a communication apparatus of the call source.

The operation section 16 has various push-button keys and is for enabling entry of a dial, a text, an instruction, and the like. The respective keys can also be touch keys provided on the screen of the display section 21. The control section 17 performs processing responsive to a key input signal from the operation section 16. The control section 17 is connected to the illumination section 22 including an LED (light emitting diode) and the vibration section 23 having a vibration motor. The control section 17 notifies an incoming call at the time of arrival of an incoming call and an incoming mail and is activated at the time of issuance of an alarm, thereby sending the alarm.

The positional information acquisition section 15 has a position acquisition antenna and acquires current positional information about the phone by way of the position acquisition antenna. The current positional information can be acquired by means of acquisition of GPS information utilizing the GPS function, acquisition of MM information, and the like.

The power supply section 18 supplies electric power to respective sections of the portable phone 100 by way of the control section 17.

FIG. 2 is a flowchart for describing example operation of the portable phone 100 of the embodiment of the present invention.

When the portable phone 100 makes a call, the operation section 16 first performs at power-on dialing operation directed by the user (step S11).

Subsequently, the control section 17 determines whether or not phone caller ID function using the text information setup function is active (step S12). When the phone caller ID function using the text information setup function is inactive (Yes), a determination is made as to whether or not the MM information has already been received (step S13). When the MM information has already been received (Yes), the control section 17 checks the MM information (step S14). In accordance with an instruction entered by way of; for instance, the operation section 16, the control section 17 can set activation/deactivation of the phone caller ID function using the text information setup function. Since the MM information is stored in the storage section 13 after having been received, a determination can also be made in step S13 as to whether or not the MM information has already been stored.

Subsequently, the control section 17 determines whether or not the a Greenwich Mean time GMT that is one of the pieces of information included in the MM information is +9; namely, whether or not the portable phone performing calling operation is present in Japan (step S15). Here, “+9” means that the Japan standard time (JST) is earlier than the Greenwich Mean Time by nine hours.

When there is “GMT=+9” or when the portable phone performing calling operation is in Japan (Yes), the control section 17 performs normal calling operation that is not a call with text information showing a call with an addition of a message involving use of the text information setup function (step S16). When the caller ID function using the text information setup function is inactive in step S12 (No) and also when the MM information has not yet been received in step S13 (No), a normal call that is not a call with text information is made (step S16). On occasion of a normal call, a message involving use of the text information setup function is not added, and the radio section 12 transmits a normal call signal.

When GMT is other than +9 in step S15; namely, when the portable phone performing calling operation is not in Japan (No), the control section 17 performs message setting operation using the text information setup function (step S17) and makes a call with text information (step S18). On occasion of a call with text information, the radio section 12 transmits a message involving use of the text information setup function along with the normal call signal (with an addition of the call signal). Specifically, voice phone call is performed with an addition of a predetermined message.

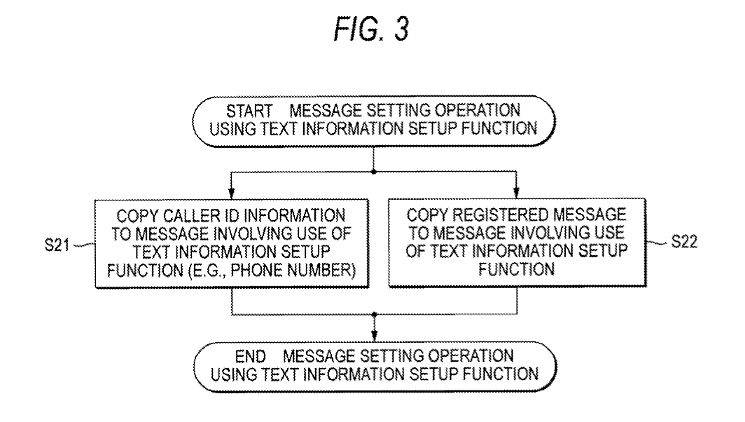

FIG. 3 is a flowchart for explaining example message setting operation using the text information setup function of the portable phone 100.

During message setting operation using the text information setup function, by means of; for instance, selecting operation performed by the operation section 16 under the user's instruction, the control section 17 copies caller ID information (e.g., a phone number) to the message involving use of the text information setup function (step S21) or copies a registered message to the message involving use of the text information setup function (step S22). Setting of the message generated by the text information setup function is thereby completed. In addition, the MM information acquired by the positional information acquisition section 15 or the country information based on the GPS information can also be set as the message involving use of the text information setup function.

The portable phone 100 performing processing shown in FIGS. 2 and 3 makes a voice phone call with an addition of a text message in accordance with the MM information about the call source, or the like. Therefore, even when the call source is outside Japan and when caller information is lost in a communication line before reaching a called party, information about the call source can be notified as a text message, and anxiety of a called party arising from an oversea call can be resolved.

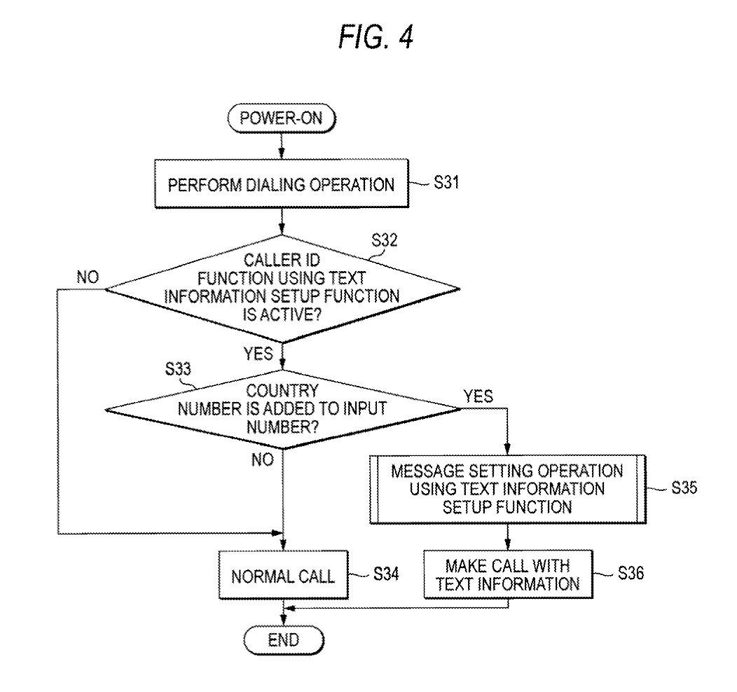

FIG. 4 is a flowchart for describing example operation of the portable phone 100 of the embodiment of the present invention performed when a call is made from home to abroad.

When a call is made from home to abroad by the portable phone 100, the operation section 16 first performs dialing operation under a user's instruction while the power of the portable phone is active (step S31). In this case, an international dial number; for instance, a country number or a phone number of a called party, is input.

Subsequently, the control section 17 determines whether or not the caller ID function using the text information setup function is active or inactive (step S32). When the caller ID function using the text information setup function is active (Yes), a determination is made as to whether or not the input phone number is provided with an addition of a country number (step S33). The control section 17 can set activation/deactivation of the caller ID function using the text information setup function under; for instance, an instruction from the operation section 16.

When the input phone number is provided with an addition of a country number (Yes), the control section 17 performs message setting operation using the text information setup function (step S35), thereby making a call with text information (step S36). Even when the input phone number is additionally provided with a country number, the country number can be deemed not to be added when the country number of Japan is designated. On occasion of a call with text information, the radio section 12 transmits the message involving use of the text information setup function along with a normal call signal (with an addition of the call signal). Specifically, voice phone call is performed with an addition of a predetermined message.

In the meantime, when the phone number input in step S33 is not provided with an addition of a country number (No), the control section 17 makes a normal call that is not the call with text information (step S34). When the caller ID function using the text information setup function is inactive (No) in step S32, the control section 17 makes a normal call that is not the call with text information (step S34). On occasion of a normal call, the message involving use of the text information setup function is not added, and the radio section 12 transmits a normal call signal.

When the input phone number is additionally provided with a country number, the portable phone 100 that performs processing shown in FIG. 4 makes a voice phone call while adding a text message to the voice call. Therefore, even when a called party is outside Japan and when caller information is lost in the communication line before arriving at the called party, the information about the call source can be notified as a text message, so that anxiety of the called party arising from an oversea call can be resolved.

Although the present invention has been described in detail and by reference to the specific embodiment, it is manifest to those skilled in the art that the present invention be susceptible to various alterations or modifications without departing from the spirit and scope of the present invention.

The present patent application is based on Japanese Patent Application No. 2007-337596 filed on Dec. 27, 2007 in Japan, the entire subject matter of which is incorporated herein by reference.

### INDUSTRIAL APPLICABILITY

The present invention can be utilized as a communication apparatus capable of notifying caller information in an oversea call, or the like.

1. A communication apparatus comprising:
a storage section that stores positional information indicating a location of the communication apparatus; and
a control section that performs control operation, when the positional information stored in the storage section indicates an oversea, so as to make a voice phone call with an addition of a phone number of the communication apparatus as a predetermined message so that the phone number of the communication apparatus is displayed as a text message on a screen of a communication apparatus at a call destination.

2. A communication apparatus comprising:
a storage section that stores positional information indicating a location of a communication apparatus of a call destination; and
a control section that performs control operation, when the positional information stored in the storage section indicates an oversea, so as to make a voice phone call with an addition of a phone number of the communication apparatus as a predetermined message so that the phone number of the communication apparatus is displayed as a text message on a screen of a communication apparatus at the call destination.

3. The communication apparatus according to claim 1, wherein the storage section stores information including MM information as the positional information; and
wherein the control section performs, when the MM Information indicates the oversea, control operation so as to make the voice phone call with the addition of the predetermined message.

4. The communication apparatus according to claim 1, wherein the storage section stores information including GPS information as the positional information; and
wherein the control section performs, when the GPS Information indicates the oversea, control operation so as to make the voice phone call with the addition of the predetermined message.

5. The communication apparatus according to claim 1, wherein the predetermined message includes information about the phone number or a user name of the communication apparatus.

6. The communication apparatus according to claim 1, wherein the predetermined message is a message generated by the control section in accordance with an operation input to an operation section.

7. The communication apparatus according to claim 1, wherein the predetermined message includes country information based on a latitude or a longitude where the communication apparatus is located.

8. A communication apparatus comprising:
a storage section that stores, as a phone directory, information about a phone number of a communication apparatus of a call source and a user name associated with each other;
an incoming call section that receives a voice call haying, as an additional predetermined message, phone number information about the communication apparatus of the call source and country information about a location of the communication apparatus of the call source when the communication apparatus of the call source is located abroad; and
a control section that, when the voice call is received, converts the phone number information included in the predetermined message into a corresponding user name by reference to the storage section, and that controls a display section to display the user name.

9. The communication apparatus according to claim 8, wherein the storage section stores map information corresponding to the country information about the location of the communication apparatus of the call source; and
wherein the control section controls the display section to display the map information corresponding to the country information included in the message by reference to the storage section along with the user name.

10. A communication method for use with a communication apparatus comprising:
a step of performing control, when making of a voice phone call is instructed and when information about a location of the communication apparatus indicates an oversea, so as to make a voice phone call with an addition of a phone number of the communication apparatus as a predetermined message so that the phone number of the communication apparatus is displayed as a text message on a screen of a communication apparatus of a call destination.

11. A communication method for use with a communication apparatus comprising:
a step of performing control, when making of a voice call is instructed and when information about a location of a communication apparatus of a call destination indicates an oversea, so as to make a voice phone call with an addition of a phone number of the communication apparatus as a predetermined message so that the phone number of the communication apparatus is displayed as a text message on a screen of the communication apparatus of the call destination.

12. A communication method for use with a communication apparatus comprising:
a storage step of storing, as a phone directory, information about a phone number of a communication apparatus of a call source and a user name associated with each other;
a step of receiving a voice call having, as an additional predetermined message, phone number information about the communication apparatus of the call source and country information about a location of the communication apparatus of the call source when the communication apparatus of the call source is located abroad; and
a step of, when a voice call is made, converting the phone number information included in the predetermined message into a corresponding user name by reference to the storage section and controlling a display section to display the user name.

13. The communication apparatus according to claim 2, wherein the storage section stores information including MM information as the positional information; and
wherein the control section performs, when the MM Information indicates the oversea, control operation so as to make the voice phone call with the addition of the predetermined message.

14. The communication apparatus according to claim 2, wherein the storage section stores information including GPS information as the positional information; and
wherein the control section performs, when the GPS Information indicates the oversea, control operation so as to make the voice phone call with the addition of the predetermined message.

15. The communication apparatus according to claim 2, wherein the predetermined message includes information about the phone number or a user name of the communication apparatus.

16. The communication apparatus according to claim 2, wherein the predetermined message is a message generated by the control section in accordance with an operation input to an operation section.

17. The communication apparatus according to claim 2, wherein the predetermined message includes country information based on a latitude or a longitude where the communication apparatus is located.
